(19) United States
(12) Patent Application Publication
(10) Pub. No.: US 2018/0115569 A1
(43) Pub. Date: Apr. 26, 2018

(54) CYBER SECURITY

(71) Applicant: Emet Rodney Anders, JR., Montgomery Village, MD (US)

(72) Inventor: Emet Rodney Anders, JR., Montgomery Village, MD (US)

(21) Appl. No.: 15/788,966

(22) Filed: Oct. 20, 2017

Related U.S. Application Data
(60) Provisional application No. 62/411,378, filed on Oct. 21, 2016.

(51) Int. Cl. H04L 29/06

(52) U.S. Cl. CPC H04L 63/1416; H04L 63/1441

(57) ABSTRACT

A method of automatically structuring data mining of computer networks is provided. The method obtains a first set of rules that define a valid transaction from data of interest providing a plurality of transactions; a second set of rules that define an association activity between each valid transaction and a plurality of suspect activity; and a third set of rules that define a cyber correlation between each association activity and entities of interest. Then the method proceeds to identify at least one valid transaction by evaluating data of interest providing the plurality of transactions against said first set of rules; generate at least one associated activity by evaluating each valid transaction and the plurality of suspect activity against said second set of rules; and generate at least one cyber correlation by evaluating each associated activity and the entities of interest against said third set of rules.

### CROSS-REFERENCE TO RELATED APPLICATION

This application claims the benefit of priority of U.S. provisional application No. 62/411,378, filed 21 Oct. 2016, the contents of which are herein incorporated by reference.

### BACKGROUND OF THE INVENTION

The present invention relates to cyber security and, more particularly, to methods and techniques for implementing a Transaction, Activity, and Correlations based Activity Based Intelligence model for supporting cyber security threat analysis.

In the world of cyber security, analysts lack a reliable model for implementing an Activity Based Intelligence (ABI) approach to processing large amounts of data related to cyber security threats and threat actors. Currently, cyber intelligence analysis is largely ad-hoc and unstructured, wherein each cyber intelligence analyst uses his or her own ad hoc method for collecting, sorting through, and categorizing threat data. This is particularly true in the cyber domain. The lack of structure or a model makes the results inconsistent, for many reasons including that they do not allow for “trace-back” or documentation of the processes to ensure confidence in findings. Ad hoc approaches to cyber security are inefficient and prone to human error.

As can be seen, there is a need for methods and techniques for implementing a Transaction, Activity, and Correlations (TAC) based Activity Based Intelligence (ABI) model for supporting cyber security threat analysis. TAC is reliable, repeatable, and teachable and allowing for the accurate and continuous documentation of both the process and methodology for determining what took place, what is taking place, and forecasting what will likely take place with respect to malicious network/cyber activity. The TAC model and process provides a structured, repeatable, rigorous method for processing information to produce actionable intelligence to support cyber investigation and decision-making. The TAC model allows for a structured approach to data collection, processing, and review, based on the analytic tradecraft inherent to ABI analysis, whereby cyber threat analysis becomes more efficient, timely, and relevant as a matter of process. The TAC model provides a formal, structured framework for addressing the problem of analyzing large amounts of “Data of Interest” (DOI).

### SUMMARY OF THE INVENTION

In one aspect of the present invention, a method of automatically structuring data mining of computer networks includes obtaining a first set of rules that define a valid transaction from data of interest providing a plurality of transactions; obtaining a second set of rules that define an association activity between each valid transaction and a plurality of suspect activity; obtaining a third set of rules that define a cyber correlation between each association activity and entities of interest; obtaining the data of interest; identifying at least one valid transaction by evaluating the plurality of transactions against said first set of rules; generating at least one associated activity by evaluating each valid transaction and the plurality of suspect activity against said second set of rules; and generating at least one cyber correlation by evaluating each associated activity and the entities of interest against said third set of rules.

In another aspect of the present invention, the above-mentioned method includes obtaining a first set of rules that define a valid transaction from data of interest providing a plurality of transactions, wherein the first set of rules defines a valid transaction accordingly at least one of the following: geo-registration for discovery, data neutrality; sequence neutrality, and integration before exploitation; obtaining a second set of rules that define an association activity between each valid transaction and a plurality of suspect activity, wherein suspect activity includes network traffic, email exchanges, or threat actor social media postings; obtaining a third set of rules that define a cyber correlation between each association activity and entities of interest, wherein entities of interest include hardware, software, or humanware involved in malicious cyber operations; obtaining the data of interest from a three-way handshake including transactions between devices, phishing emails, and malware activations; identifying at least one valid transaction by evaluating the plurality of transactions against said first set of rules; generating at least one associated activity by evaluating each valid transaction and the plurality of suspect activity against said second set of rules; and generating at least one cyber correlation by evaluating each associated activity and the entities of interest against said third set of rules.

These and other features, aspects and advantages of the present invention will become better understood with reference to the following drawings, description and claims.

### BRIEF DESCRIPTION OF THE DRAWINGS

FIG. 1 is a schematic view of the data integration and command flow of an exemplary embodiment of the present invention;

FIG. 2 is a schematic view of an exemplary embodiment of the relationship of present invention components; and

FIG. 3 is a flow chart of an exemplary embodiment of the present invention process.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a method of automatically structuring data mining of computer networks includes obtaining a first set of rules that define a valid transaction from data of interest providing a plurality of transactions; obtaining a second set of rules that define an association activity between each valid transaction and a plurality of suspect activity; obtaining a third set of rules that define a cyber correlation between each association activity and entities of interest; obtaining the data of interest; identifying at least one valid transaction by evaluating the plurality of transactions against said first set of rules; generating at least one associated activity by evaluating each valid transaction and the plurality of suspect activity against said second set of rules; and generating at least one cyber correlation by evaluating each associated activity and the entities of interest against said third set of rules.

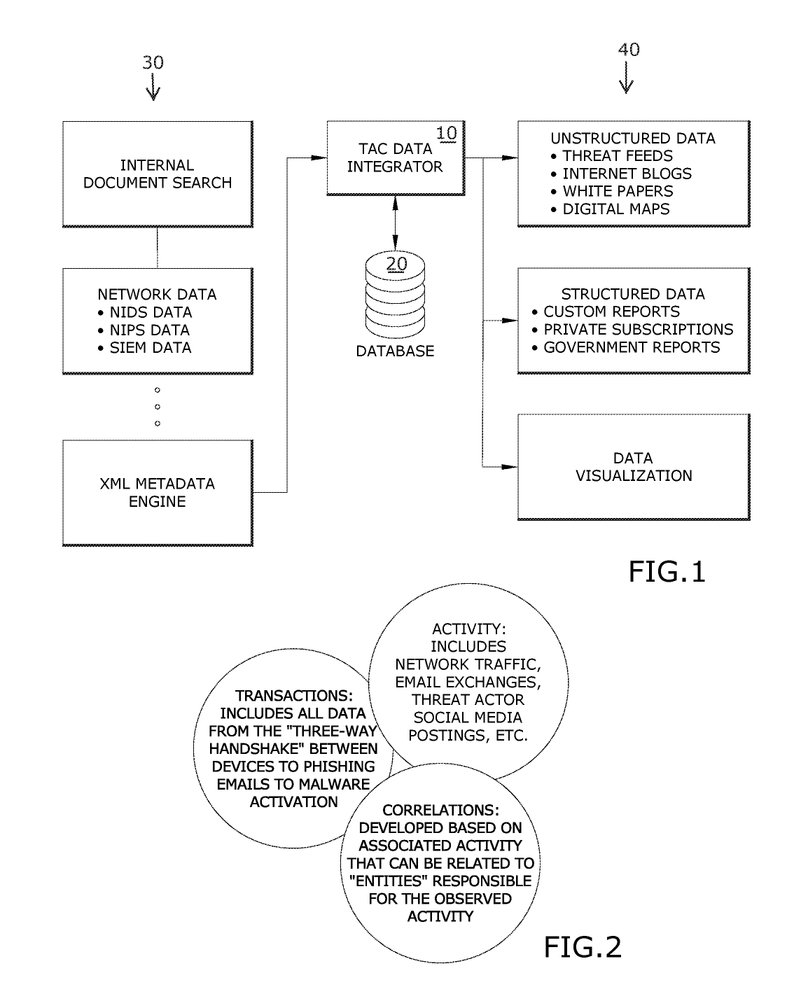

Referring to FIGS. 1 through 3, the present invention may include at least one computer with a user interface. The computer may include at least one processing unit coupled to a form of memory including, but not limited to, a desktop, laptop, and smart device, such as, a tablet and smart phone. The computer may include a program product or the like providing a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using a network environment such as the Internet, extranet, intranet, host server, internet cloud and the like.

Referring to FIG. 1, the computer may include a TAC data integrator 10 coupled to a database 20. The TAC data integrator 10 may be coupled—via said network environment—to “Data of Interest” (DOI) 30, including, but not limited to, data produced internally and information that may come from external sources. The DOI 30 may come from any relevant sources to include, but not limited to, host and server Security and Event files, internal document search result data, network data, XML metadata, output for Intrusion Detection Systems (IDS's) or sensors for monitoring network activity, threat feeds and Open Source Intelligence (OSINT) sources and social media, and the like. The DOI 30 can be in any format, text, images, or audio.

The TAC data integrator 10 may provide a first set of rules to apply to the DOI for identifying valid “transactions”. The first set of rules may define “transactions” accordingly to “four pillars” or principles of ABI: 1. Geo-registration for discovery; 2. Data Neutrality; 3. Sequence Neutrality, and 4. Integration before Exploitation.

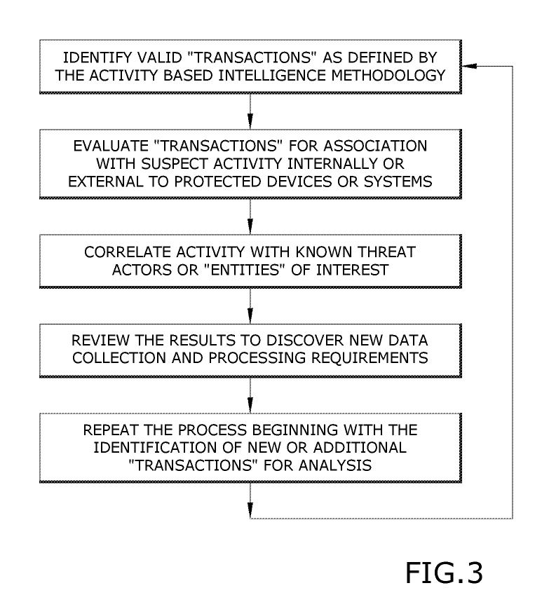

Referring to FIGS. 2 and 3, valid transactions in the context of cyber threat analysis includes all data from the “Three-way Handshake” between devices to Phishing emails to malware activation. The TAC data integrator 10 may provide a second set of rules to apply to the identified valid transaction for evaluating valid transactions' association with “suspect activity” internally or externally to protected devices or systems. The suspect activity associated with transactions may include, but may be not limited to, network traffic, email exchanges, or threat actor social media postings. Valid transactions revealed to be associated with suspect activity, or in other words “associated activity,” would be compiled by the TAC data integrator 10. The TAC data integrator 10 may provide a third set of rules to apply to the associated activity for correlating said associated activity with known and potential threat actors or “entities of interest” (EOI) responsible for the associated activity. EOI can be hardware, software, or “Humanware” in nature involved in suspect and malicious cyber operations. The present invention may output “Cyber Correlations” equivalent to associated activity sufficiently correlated to EOI.

The present invention may enable analyst-users to review resulting cyber correlations to discover new data collection and processing requirements, for example by electronically recording the “representative DOI 40” on the user interface in categories such as unstructured data, structured data, and data visualization. The present invention may retrievably store newly minted cyber correlations in the database 20. The present invention may then repeat the process beginning with the identification of new or additional “transactions” for analysis. The model embodied in the present invention is iterative in nature with the purpose of being both structured and repeatable. The features of the TAC process are both independent and interdependent. And because the model is iterative, it can be automated. The model is also agnostic with respect to tools and techniques. The model applies structure to a process where there currently is none.

A method of using the present invention may include the following. The TAC data integrator 10 and attendant modalities and sets of rules disclosed above may be provided. An analyst-user can rely on the present invention to identify valid transactions by combing through a mountain of DOI 30. The analyst-user may thereby be enabled to see both the immediate picture and the larger picture to include suspect and associated activity and the EOIs that may have been previously undetected and unknown through, in one embodiment, the representative DOI 40. The analyst-user can “pivot” to review transactions that may be observable in the data to identify significant activity that may be relevant and worthy of correlation. Therefore, although the process is iterative, the model is sufficiently flexible to produce actionable cyber threat intelligence at any stage of the process, allowing breakout at any stage. The key feature being the return to the model and the repeatability when new DOI 30, or EOI are discovered from both internal and externally network sources.

The present invention does not preclude the use of other methods or techniques such as the “Cyber Kill Chain” or the “Diamond Model” within the framework of the TAC model. In other words, the TAC process embodied in the present invention can be used by any Cyber Intelligence Analyst charged with the task of detecting, identifying, categorizing, and counter cyber threats and cyber threat actors. The model can be used by individual analysts work in a small organization or small business. The model can also be institutionalized as part of standard operating procedure (SOP) for Security Operations Centers (SOC's) or Security Intelligence Centers (SIC's) regardless of size.

The present model may also be ideal for supporting large Data Mining efforts with respect to cyber threat activity by providing the analytical structure to what is often an ad hoc process at best and undocumented at worst. Furthermore, the model provides the framework for automating the efficient mining of “Big Data” for cyber security defense.

Additionally, the present invention model can be used to inform and shape the design of automated tools to both lessen the burden on the analyst but also to support the analyst by giving him or her more time to do what humans do best: analyze. Although optimized for cyber, TAC can be used for any “Big Data” problem describing “Human” activity. Also, the present invention can create automated intelligence analysis software applications based on the TAC method.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A method of automatically structuring data mining of computer networks comprising:
obtaining a first set of rules that define a valid transaction from data of interest comprising a plurality of transactions;
obtaining a second set of rules that define an association activity between each valid transaction and a plurality of suspect activity;
obtaining a third set of rules that define a cyber correlation between each association activity and entities of interest;
obtaining the data of interest;
identifying at least one valid transaction by evaluating the plurality of transactions against said first set of rules;
generating at least one associated activity by evaluating each valid transaction and the plurality of suspect activity against said second set of rules; and
generating at least one cyber correlation by evaluating each associated activity and the entities of interest against said third set of rules.

2. The method of claim 1, wherein the first set of rules defines a valid transaction accordingly at least one of the following: geo-registration for discovery, data neutrality; sequence neutrality, and integration before exploitation.

3. The method of claim 1, wherein data of interest comprises data from a three-way handshake.

4. The method of claim 3, wherein the three-way handshake comprises transactions between devices, phishing emails, and malware activations.

5. The method of claim 1, wherein suspect activity comprises network traffic, email exchanges, or threat actor social media postings.

6. The method of claim 1, wherein entities of interest comprise hardware, software, or humanware involved in malicious cyber operations.

7. A method of automatically structuring data mining of computer networks comprising:
obtaining a first set of rules that define a valid transaction from data of interest comprising a plurality of transactions, wherein the first set of rules defines a valid transaction accordingly at least one of the following: geo-registration for discovery, data neutrality; sequence neutrality, and integration before exploitation;
obtaining a second set of rules that define an association activity between each valid transaction and a plurality of suspect activity, wherein suspect activity comprises network traffic, email exchanges, or threat actor social media postings;
obtaining a third set of rules that define a cyber correlation between each association activity and entities of interest, wherein entities of interest comprise hardware, software, or humanware involved in malicious cyber operations;
obtaining the data of interest from a three-way handshake comprising transactions between devices, phishing emails, and malware activations;
identifying at least one valid transaction by evaluating the plurality of transactions against said first set of rules;
generating at least one associated activity by evaluating each valid transaction and the plurality of suspect activity against said second set of rules; and
generating at least one cyber correlation by evaluating each associated activity and the entities of interest against said third set of rules.
